(19) United States
(12) Patent Application Publication
(10) Pub. No.: US 2015/0235254 A1
(43) Pub. Date: Aug. 20, 2015

(54) ADAPTIVE DYNAMIC CODING BENEFITS PROGRAM

(71) Applicant: White Castle Management Co., Columbus, OH (US)

(72) Inventors: Susan Carroll-Boser, Worthington, OH (US); Abderrezak Allalen, Upper Arlington, OH (US); Anindita Ghosh, Westerville, OH (US); Ashley Loveless, Cable, OH (US); John Miller, Hilliard, OH (US)

(73) Assignee: White Castle Management Co., Columbus, OH (US)

(21) Appl. No.: 14/181,066

(22) Filed: Feb. 14, 2014

(51) Int. Cl. G06Q 30/02

(52) U.S. Cl. CPC G06Q 30/0226

(57) ABSTRACT

A computer-implemented adaptive benefits program may be implemented by storing benefits program data in memory of a point of transaction device, reading an adaptive data matrix in association with a transaction, offering a benefit to user or customer in the transaction, and transmitting transaction data indicative of the offer from the point of transaction device. The adaptive data matrix can be configured to define user data indicative of the user or customer, and transaction history data indicative of a transaction history of the user or customer. The benefit offering can be selected based on the transaction history in combination with the benefits program data stored in memory. The transaction data can be selected for updating the transaction history based on the transaction, and for modifying the adaptive data matrix accordingly.

### BACKGROUND

This disclosure relates generally to customer benefits, and specifically to benefits programs configured for retail sales and other customer transactions. In particular, the disclosure relates to an adaptive benefits program for retail store transactions, including, but not limited to, restaurant sales.

Early customer benefits and loyalty programs were typically paper-based, for example using advertising coupons or tokens provided with the product packaging or stamps collected at the point of sale, with rewards based on purchase items or sales amounts. Many of these legacy programs remain popular today, and a wide range of supermarkets, gas stations, restaurants, and other retail companies still participate in them, for example in the form of a punched or stamped cards that provide for one or more free or discounted items, after a number of similar items are purchased.

Customer rewards programs are also popular in the service and travel industries. In the travel sector, for example, airline frequent flyer programs generally offer rewards based on flight segments, mileage, and class of service. Frequent flyer programs can also be tied to related offers from hotel chains and rental car agencies, and many of these businesses operate independent rewards programs as well.

As opposed to paper-based brand loyalty and rewards systems (e.g., punch cards, stamps and coupons), frequent flyer programs and other travel sector applications may apply a more strategic approach to customer data management, where incentives are applied based on overall behaviors of the customer base. This is also typical of “loyalty card” systems, where customer data may be fixed in electronic form on a magnetic card or other device, and utilized to track behavior of the customer base over time. Banking and credit card companies also utilize sales tracking, not only for customer loyalty and rewards programs, but also for fraud detection and loss prevention.

While existing marketing strategies are directed primarily at the dollar value of the customer proposition (that is, the decision by any one customer to make a particular purchase), it is less obvious how these programs affect other goals, both tangible and intangible. While sales may be one factor in the customer relationship, moreover, successful companies may also consider branding and marketing strategies directed to other tangible and intangible factors that impact the customer experience, and ultimately reflect on the overall business image.

As a result, existing large-scale, real-time data intensive programs focused solely on incentives and other sales-directed tools may not be entirely suitable for businesses that take a broader approach to the customer proposition. In particular, fixed incentive programs and other existing customer rewards programs focused on sales in isolation may fail to account for additional factors related to broader, longer-term goals for improved customer and client relationships, not only with respect to the business itself, but also within the broader client community.

### SUMMARY

This application is directed to adaptive benefits programs, including, but not limited to, computer-implemented and server-based systems and methods utilizing a dynamic, adaptive data matrix, such as a two-dimensional bar code or other graphical data representation. To implement such methods and systems, benefits program data can be stored in memory at a point of transaction device, for example a point of sale terminal. The data matrix can be read in association with a transaction performed on the transaction device, for example using an optical scanner to read a two-dimensional data matrix on a mobile device or fob.

The data matrix defines user data indicative of a user, and transaction history data indicative of a transaction history of the user. Benefits can then be selected for offer in the transaction, based on the user (or customer) transaction history in combination with the benefits program data stored in memory. Transaction data are transmitted to the remote server, in order to update the transaction history with the offering made in the transaction, and for modifying the adaptive data matrix accordingly.

Depending on application, the transaction data may be transmitted in an asynchronous batch mode, for example daily or nightly, or at other asynchronous intervals. The remote server can configured to update the dynamic data matrix, for example using a wireless server interface. An external website or web server can also be provided for additional user interactions, including customer registration and ticket entry for transactions where the adaptive coding matrix was not used, and for a range of non-commercial activities including games, puzzles, and community events.

### BRIEF DESCRIPTION OF THE DRAWINGS

FIG. 1 is a block diagram of a server-based system for implementing an adaptive benefits program with a dynamic; adaptive data coding matrix.

FIG. 2 is a block diagram illustrating a set of representative software modules in a computer process implementation of the adaptive benefits program.

FIG. 3 is a block diagram of a representative server-based system for implementing the adaptive benefits program.

FIG. 4 is an illustration of an initiative goal interface for the adaptive benefits program.

FIG. 5 is an illustration of a segmentation interface for the adaptive benefits program.

FIG. 6 is an illustration of a segmentation split and offer distribution interface for the adaptive benefits program.

FIG. 7A is an illustration of a marketing initiative goal analysis interface for the adaptive benefits program.

FIG. 7B is an illustration of an alternate marketing initiative goal analysis interface for the adaptive benefits program.

FIG. 8 is an illustration of a segmentation grouping interface for the adaptive benefits program.

FIG. 9 is an illustration of an ID benefits interface for the adaptive benefits program.

FIG. 10 is an illustration of an order detail interface for the adaptive benefits program.

FIG. 11 is an illustration of a customer survey interface for the adaptive benefits program.

### DETAILED DESCRIPTION

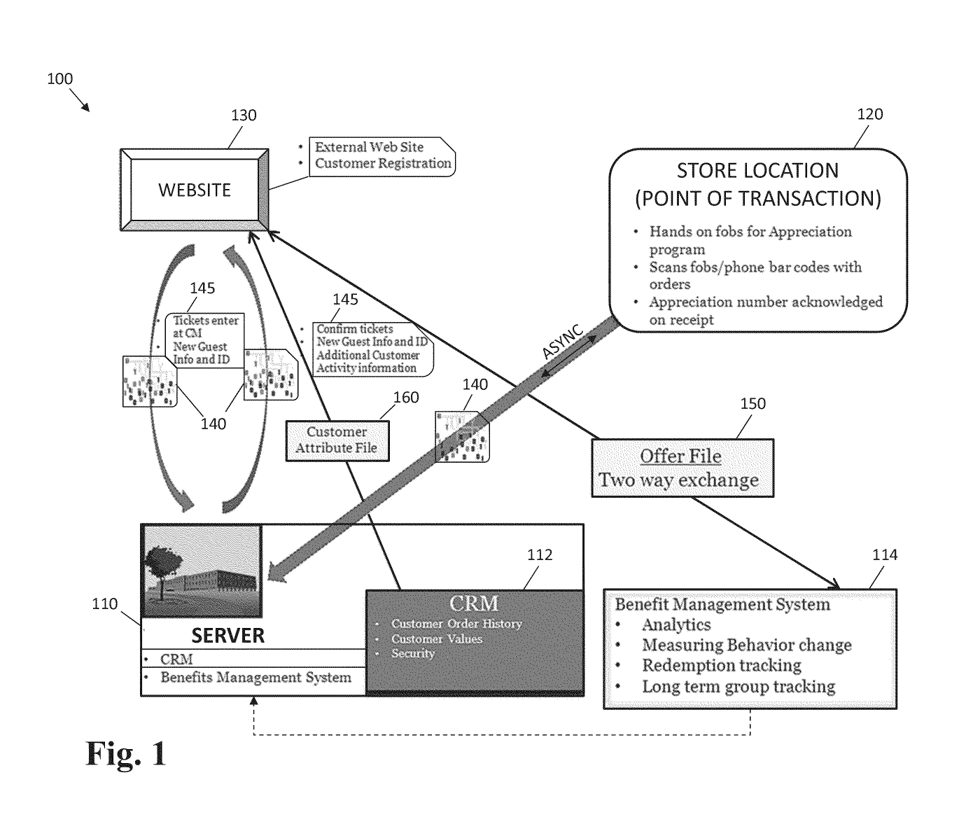

FIG. 1 is a block diagram illustrating server-based system 100 for implementing an adaptive benefits program, as described herein. In this particular example, system 100 includes server 110 in data communication with a store location or other point of transaction system 120, for example utilizing asynchronous batch mode communications to upload transaction data, as shown in FIG. 1. Server 110 may also maintain a secure internet data connection to external website or web server 130.

In the particular example of FIG. 1, server 110 includes customer records manager (CRM) 112 and benefits management system (BMS) 114, as configured for benefits and customer/client relationship management. These components may be provided in the form of an integrated server 110, or as separate systems utilizing a local area network (LAN), a wide-area network (WAN), or secure cloud-based communications between and among server 110, records manager 112 and benefits management system 114.

Customer records manager 112 may be provided, e.g., in the form of a database or other memory system, or as a client records module. In transaction-based applications, for example, records manager 112 will typically include various data storage media and memory components for storing data representing customer order and transaction histories, customer values, and security data associated with individual users, customers or client profiles, and for updating and managing these records based on associated transaction data received from point of transaction system 120.

Benefits management system (or benefits module) 114 includes processing components in communication with records manager 112, and configured to perform customer and benefits analysis, guest appreciation analytics, and other benefits management functions. For example, benefits management system 114 may utilize executable software code for measuring changes in customer behaviors and redemption tracking for rewards offers, based on individual customer transactions history data stored in records manager 112. Benefits management system 114 can also be configured to perform short, intermediate, and long-term analytics and user or customer tracking, using combinations of different transaction records from records manager 112, for the same or different customers and segmentation groups.

Point of transaction system 120 is adapted to scan a bar code or other graphical data matrix presented by a user in a transaction, for example a two-dimensional data matrix presented in a sales transaction. Generally, the data matrix defines or represents user data associated with a particular user, and transaction data relating to a transaction history of the user. Depending on application, the data matrix can be presented on a user cell phone or other mobile device, using a physical token such as a fob, in hard copy form, or in a magnetic or radio-frequency data device.

In one particular application, transaction system 120 includes a point of sale (POS) terminal or similar device connected to a data matrix scanner, for use in a dynamic benefits program based on adaptive data matrix coding. Point of transaction system 120 can thus be adapted for a hands-on fob or mobile device-based user appreciation or customer benefits program, implemented via a variety of different coding schemes and hardware. The data matrix itself can also be provided in dynamic or adaptable form, where at least some of the data represented by the data matrix are updated from time to time based on user transaction history.

In some of these applications, point of transaction system 120 is provided in a store location or other retail outlet. Periodic transaction data uploads and benefits program updates are provided via batch mode communications with server 110, for example at intervals that are asynchronous with respect to the transactions themselves (e.g., once a day, at night, or at some other asynchronous interval). The location of transaction systems 120 may also vary, along with the associated transaction types, in order to provide a benefits program with a broader transactional history. In particular, the contemplated transactions also include non-commercial activities, including participation at charitable events and other community activities, and location visits where no commercial transaction is necessarily performed.

In operation of adaptive benefits system 100, a customer, client or other user presents an adaptive bar code or two-dimensional data matrix to point of transaction system 120, for example utilizing an optical code reader coupled to a point of sale terminal at a restaurant, store, or other retail location. The code reader scans the data matrix to extract a customer identification and transaction history, which is used to select an individually tailored, adaptable customer benefit for offer in the transaction.

Transaction data 140 are transmitted from point of transaction system 120 to server 110, for example using asynchronous batch mode communications based on a periodic data upload schedule, as described above. Server 110 and point of transaction system 120 may also provide for two-way and return communications, for example to asynchronously update the transactional software and benefits program data in point of transaction system 120.

Web server 130 provides for a range of web-based user access features, including external website access, customer/user registration, online ordering, and non-commercial transactions including games, puzzles, and charitable or community event participation (or “eventing”). Server 110 exchanges additional transaction data or information 140 with web server 130. Web-based transaction data 140 may also be supplemented by user-entered or web-based data 145, for example new or existing guest/user information and identification data, and associated transactional data.

For example, user-entered data 145 may include transactional information such as a ticket number or other transaction identifier used to associate the user with additional transaction data 140, for example sales or visits at the location of a particular point of transaction system 120. This feature provides for user verification of particular transactions, ensuring credited to the associated benefits account. Users can also enter additional transactional information, for example when the user forgets or neglects to present their personal data matrix during a given transaction. Web-based transaction data 140 can also reflect online ordering and non-commercial interactions with web server 130, for example customer surveys, gaming and event participation data, as described above.

Both online and in-store offers can thus be generated in combination with individual user transactional data 140, for example based on offer file data 150, as exchanged between web server 130 and benefits management system 114. Offer file data 150 can also include additional data 145 generated via web server 130, for example online ordering data and online benefits data indicating whether particular online offers have been reviewed or accepted by an individual customer, client, or other user.

Customer records manager (CRM) 112 also exchanges data with web server 130, including customer attribute file data 160. Customer attribute file data 160 may include additional customer data upon which individual offers are presented, including updated customer transaction histories and other user data stored in records manager 112.

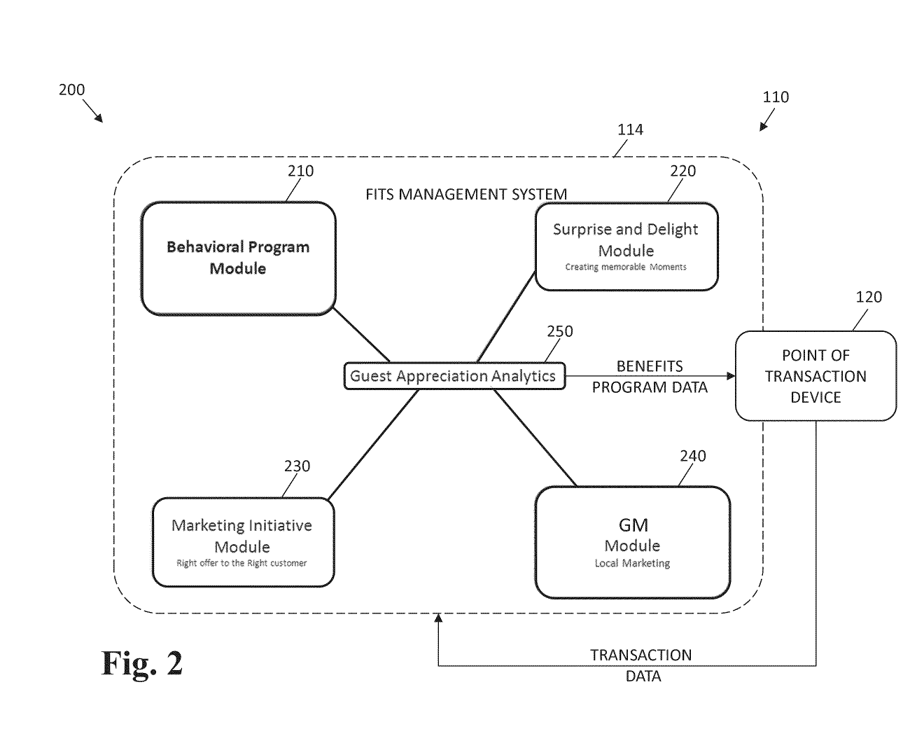

FIG. 2 is a block diagram illustrating a representative program architecture for server 110, as configured to implement a computer-executed system, process or method 200 for providing the adaptive benefits program features described herein. In the particular example of FIG. 2, computer-implemented process 200 encompasses a number of individual program modules including, but not limited to, behavior program module (BPM) 210, surprise and delight module (SDM) 220, marketing initiative module (MIM) 230, and a generalized marketing module (GMM) 240.

Process 200 may be implemented within a particular benefits management system 114, for example as shown in of FIG. 1, or within another component of benefits program server 110. In addition, individual benefits program modules 210, 220, 230 and 240 may exchange data with a processor module, for example guest appreciation analytics (GAA) processor 250.

Program and processor modules 210, 220, 230, 240 and 250 include a combination of computer-readable software and/or firmware, executable on processor module 250 (or other computer processors) to provide the adaptive benefits program features described herein. In particular, program and processor modules 210, 220, 230, 240 and 250 can be implemented via executable program code stored on one or more non-transitory computer-readable data storage media, and provided in combination with processor, memory and data components configured to implement adaptive benefits method or process 200 by executing the code and manipulating the associated data structures.

Behavioral program module (BPM) 210 encompasses software, firmware and/or hardware components configured to generate offers that can influence user or customer behavior, including transaction-based offers and other storefront or location-based benefits. Behavioral program module 210 can also generate web-based offers and benefits, including extrinsic (non-product based) tokens or “medals” and awards (real or virtual) based on non-commercial transaction history, including location visits (whether a purchase was actually made or not), charitable activities, community events, and other customer and user transaction data.

Surprise and delight module (SDM) 220 encompasses software, firmware and/or hardware components configured to generate individually selected offers and benefits, for example using a combination of user transaction data and a random number or random event generator distribute a limited number of items among a given customer segmentation, or to differentiate between control and test groups. Surprise and delight module 220 is also configured to generate benefits and offers that create memorable moments based on benefits that may be unknown to the user or customer prior to the offering in a given transaction, and which cannot be predicted on the basis of user transaction data alone. Surprise and delight module 220 thus distinguishes process 200 from other, more predictable benefits programs, including points-based and transaction-based systems with fixed reward scales, and from birthday, holiday, and other fixed calendar-based reward programs and offerings.

Marketing initiative module (MIM) 230 encompasses software, firmware and/or hardware components configured to generate individualized customer offers and other user-specific benefits, based not only on user transaction history but also on additional information including demographic group, location, and time of day. Marketing initiative module 230 can also be configured to adapt individual customer offers and benefits to larger-scale marketing initiatives based on product selection, transaction frequency, speed of service, and other transactional goals. Marketing initiative module 230 can generate offers based on either a customer-wide or segmentation basis, including not only demographics and geography, but also provide for analysis based on offer redemption rates and web-based transaction data, including not only online ordering but also survey results, website interactions, event participation and other non-commercial transaction activity.

General marketing module (GMM) 240 encompasses software, firmware and/or hardware configured to generate additional offers and benefits based on local (i.e., location-based) marketing initiatives. Local marketing initiatives are distinguished from global or company-wide initiatives based on individual store or transaction locations, geographical regions, and other location-based characteristics. Local marketing initiatives include not only intrinsic offers and benefits directed to locally available products and services, but also extrinsic offers and benefits based on non-commercial opportunities, for example participation in local community activities or charitable events, or visits to a particular store location, for example at a particular time or within a particular date range, regardless of whether items were purchased in the same transactions or not.

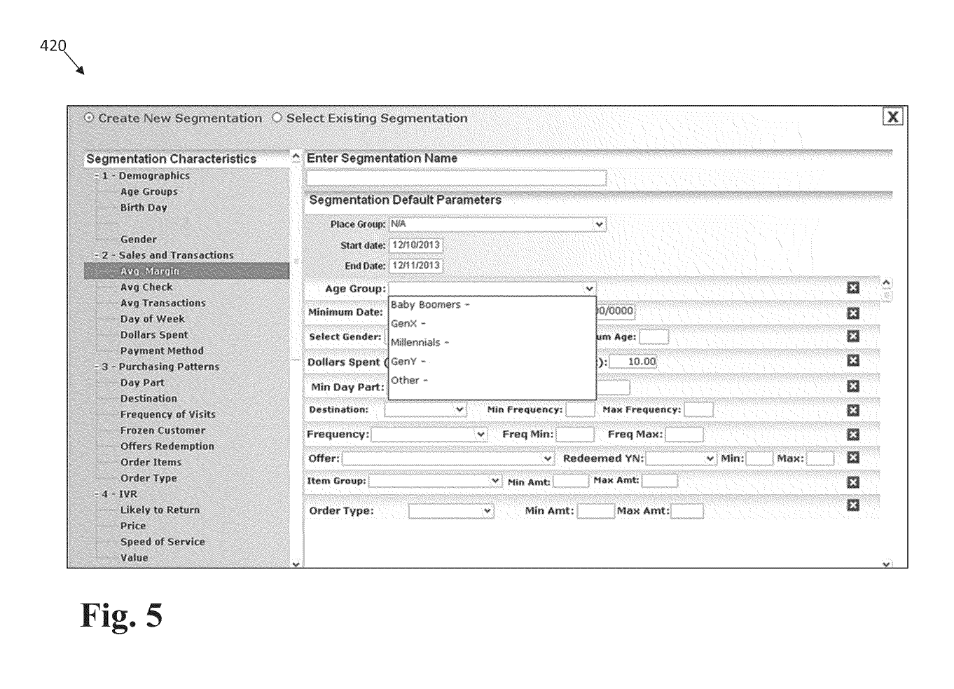

As shown in FIG. 2, individual program modules 210, 220, 230 and 240 may each exchange data with a central processor module in the form of guest appreciation analytics (GAA) processor 250. Guest appreciation analytics processor 250 is configured to generate benefits program data for point of transaction system 120, defining individual program offers and benefits for a given set of user data and transaction history, based on outputs of behavioral program module (BPM) 210, surprise and delight module (SDM) 220, marketing initiative module (MIM) 230, and general marketing module (GMM) 240. Particular examples of such benefits data input and offer outputs are presented in the interface illustrations of FIGS. 5-12, below.

Note that the particular representation of FIG. 2 is merely exemplary, and the number and configuration of individual program and processor modules 210, 220, 230, 240 and 250 may vary. In particular, one or more program and processor modules 210, 220, 230, 240 and 250 may share executable software code and firmware, as well as processor, memory, and other hardware components. Alternatively, one or more program and processor modules 210, 220, 230, 240 and 250 may be executed on separate or distinct computer processors and memory components, utilizing a variety of different local, wide area and cloud-based network connections, for example as described above with respect to benefits management system 112 and server 110 of FIG. 1.

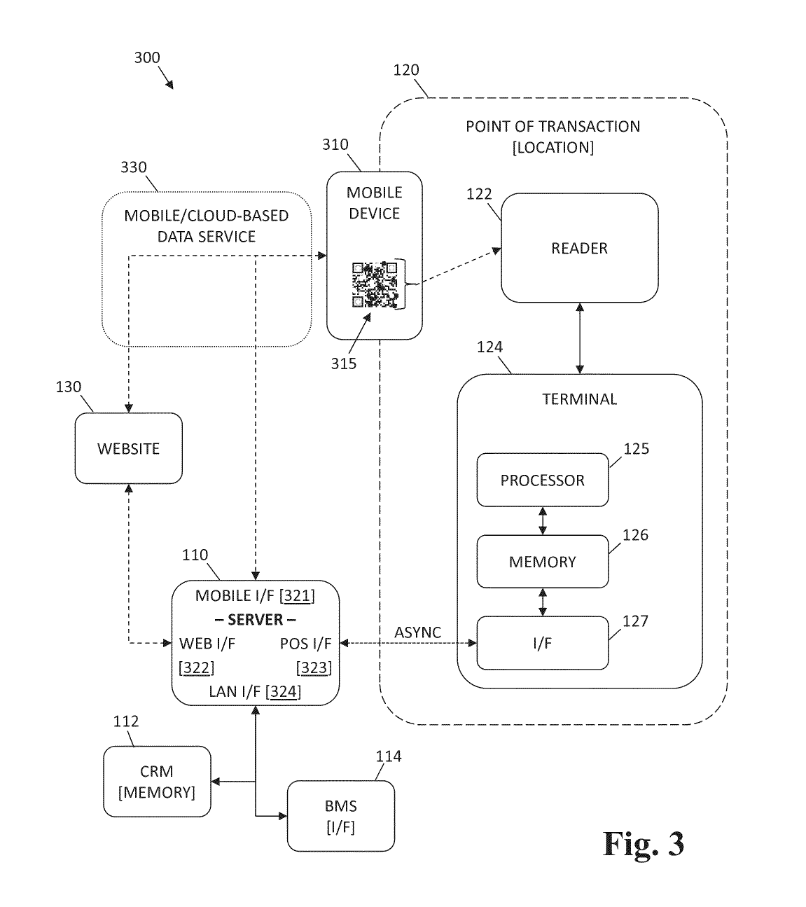

FIG. 3 is a block diagram of a representative computer-based adaptive benefits system 300, as configured for implementing any of the adaptive benefits program features described herein. System 300 may include a server 110 with data manager 112 and benefits management system 114, a point of transaction system or apparatus 120, and a web server 130, for example as described above with respect to benefits system 100 of FIG. 1.

In the particular configuration of FIG. 3, adaptive benefit system 300 is configured for use with a mobile device 310, which is utilized to display a dynamic data matrix 315 for presentation to point of transaction system 120. Mobile device 310 may take the form of a mobile phone, smartphone, media player, tablet computer, or other portable electronic device.

Point of transaction system (or apparatus) 120 includes reader 122 in data communication with transaction apparatus or terminal/register device 124. Transaction interface (or terminal) 124 includes local point of transaction processor 125 and memory 126 for storing benefits program data received from remote server 110, for example via an asynchronous server interface 127.

Reader 122 is configured for reading adaptive data matrix 315, as presented by a customer or other user. Adaptive data matrix 315 defines user data indicative of the user identification, and transaction history data indicative of the user's transaction history. Depending on application, an optical scanner or reader device 122 may be utilized, as configured to scan a graphical representation of adaptive data matrix 315 in order to extract the user identification and transaction history data, for use in a transaction with transaction terminal 124. Alternatively, a token-based dynamic data matrix 315 may be presented, for example using a fob or other device, or the user may present data matrix 315 in updatable hard copy form. In further examples, a magnetically coded card-based or radio-frequency (RF) data element 315 may be provided, with a correspondingly configured magnetic card or RF reader 122.

Transaction device 124 is configured for offering a benefit to the user, for the corresponding transaction in which data matrix 315 is presented. The benefit offer is selected by point of transaction system 120 based on the transaction history and user identify defined by adaptive data matrix 315, in combination with the benefits program data stored in memory 126. In particular applications, the benefit is selected locally, absent real-time communication with remote server 110, at the time of the transaction with the user.

In particular, the benefit may be selected using local processor 125 of transaction device or terminal 124, based on the benefits program data stored in local memory 126 in combination with the user identify and transaction history data determined by reading or scanning adaptive data matrix 315. In these applications, the benefits program data can be updated asynchronously, with the corresponding transaction data transmitted in batch mode. Thus, the benefits and offerings can be selected locally by point of transaction system 120, without requiring (that is, absent) real-time communication between point of transaction system 120 and remote server 110, at the time of the user transaction.

Data or server interface 127 is configured for transmitting transaction data corresponding to the user transaction to remote server 110, for example in asynchronous batch mode as described above. The transaction data may be indicative of the user identification and the offering made in the transaction, and selected for updating the users transaction history stored in server 110, for example in records manager 112. Additional transactional data include items purchased, date and time of the transaction, elapsed service time, employee number and store location, as well as whether a particular benefit offer was accepted by the customer, in the corresponding transaction.

Server interface 127 is also configurable to receive updated benefits program data from server 110, in asynchronous mode, independent of the actual transaction time. In certain applications, one or more selected items of the transaction data and benefits program data may also be uploaded or updated synchronously, or in real time during the transaction itself. Real-time data transfers may be related, for example, to loss control operations, or to other commercial or non-commercial transactional activity.

Server 110 updates or modifies adaptive data matrix 315 accordingly, and transmits user benefits data representing the modified matrix. For example, server 110 may transmit updated user benefits and matrix data to mobile device 310 via a mobile interface (I/F) 321, as configured for data transmission in cooperation with a mobile communications service.

The modified adaptive data matrix defines updated transaction history data, which is in turn indicative of the updated transaction history of the user. Data matrix updates can be performed asynchronously, for example nightly or daily, or in real-time, for example to reflect online ordering information in the updated data adaptive data matrix 315.

Thus, the user transaction history can also be updated via web interaction data received from web server 130, via web interface 322. Representative web interaction data include user data input to the website, for example new or updated user identification information and transaction ticket data, as described above. Web interaction data can also include other interactions with web server 130, including user (or customer) survey data, user preferences, and non-commercial interactions including gaming, puzzle solving, and data representing charitable and community activities, as well as online ordering data.

In some examples, server interface 127 is configured for transmitting the transaction data to server 110 and receiving updated benefits program data from server 110 via point of transaction or point of sale (POS) interface 323, for example in an asynchronous batch mode. In this mode, communications between serer 110 and point of transaction system 120 can be performed at periodic intervals, e.g., daily, nightly, at particular hour intervals, or at other aperiodic intervals, as defined independently of the actual (real) time of a given transaction with any particular user. Alternatively, selected transactional and/or benefits program data may be updated synchronously or in real time, as described above, or using a combination of synchronous and asynchronous, communication modes.

Adaptive data matrix 315 is generated and updated based on user benefits data received from remote server 110, where the user benefits data reflected individual user transaction histories. As shown in FIG. 3, for example, adaptive data matrix 315 can be dynamically generated on mobile device 310 based on user benefits data transmitted via a mobile communications or cloud-based data service 330, which maintains data communications with server 110 via mobile communications interface 321. Remote server 110 can also configured to update the transaction history of selected users based on transaction data received from point of transaction system 120, in combination with web interaction data received from web server 130. Thus, the user benefits data transmitted to the mobile device also reflect the selected user's updated transaction history.

Depending on the particular systems and methods utilized, at least a portion of the benefits program data may not be available to the user prior to the transaction, so that the corresponding benefits are unknown to the user prior to the offering. In principle, for example, a user could decode the data on the adaptive data matrix, or verify the user's transaction history via web server 130. Nonetheless, the particular benefits offered at point of transaction system 120 may also depend on other factors, for example as defined by adaptive benefits process 200 of FIG. 2, e.g., using benefits program data generated by guest appreciation analytics processor 250 based on the output from any one or more of behavioral program module 210, surprise and delight module 220, marketing initiative module 230, and general (or local) marketing module 240.

In additional system and method applications, the transaction data transmitted to server 110 may include location data indicative of the location from point of transaction system 120, and the benefit may be selected at least in part based on the location. Suitable location-based benefit selections include not only tangible, intrinsic benefits such as product offerings, but also intangible, extrinsic benefits such as a virtual icons, awards, or “badges” available via web server 130.

Suitable virtual and real icons and tokens may be indicative of a visit by the user to a particular location where the user presented his or her adaptive data matrix 315, for example a store location, or indicating the presence of the user at a charitable event or community activity. The transaction history defined by the adaptive data matrix can also be updated based on such location visits, in order to generate additional (future) benefit offering based on location data.

Additional transaction history data can also be represented in adaptive data matrix 315, for example online ordering data, in which case the benefit may include or be associated with the online order. For example, point of transaction processor 125 may recall a customer's online order in response to presentation of adaptive data matrix 315, and an associated benefit may be provided, for example a discount offering for a future online order, or a pre-payment based discount.

Benefit offerings can also be selected based on service time, as reflected in the transactional data transmitted to server 110. For example, a discount for a suggested order item or order combination may be provided, where the order item or combination is selected in order to reduce average transaction time and/or increase customer satisfaction for the associated client or user.

Loss control information can also be transmitted from point of transaction system 120 to the remote server. Suitable loss control information includes, but it not limited to, user data indicative of the customer involved in a given transaction, and transaction data indicative of form of payment, items purchased or received, benefits accepted or rejected, and an employee identifier identifying an employer conducting the transaction with the user, at the particular location associated with the point of transaction device.

In order to manage these adaptive benefits program features, benefits server 110 is provided in data communication with records manager 112 and benefits management system 114, for example via a local area network, data bus, or other data interface 324.

Customer records manager 112 includes memory configured for storing a plurality of individual customer transaction histories. A graphical interface and processor components can also be provided, in order to update selected customer transaction histories based on transaction data received from point of transaction system 120, and to manage the corresponding customer-specific data.

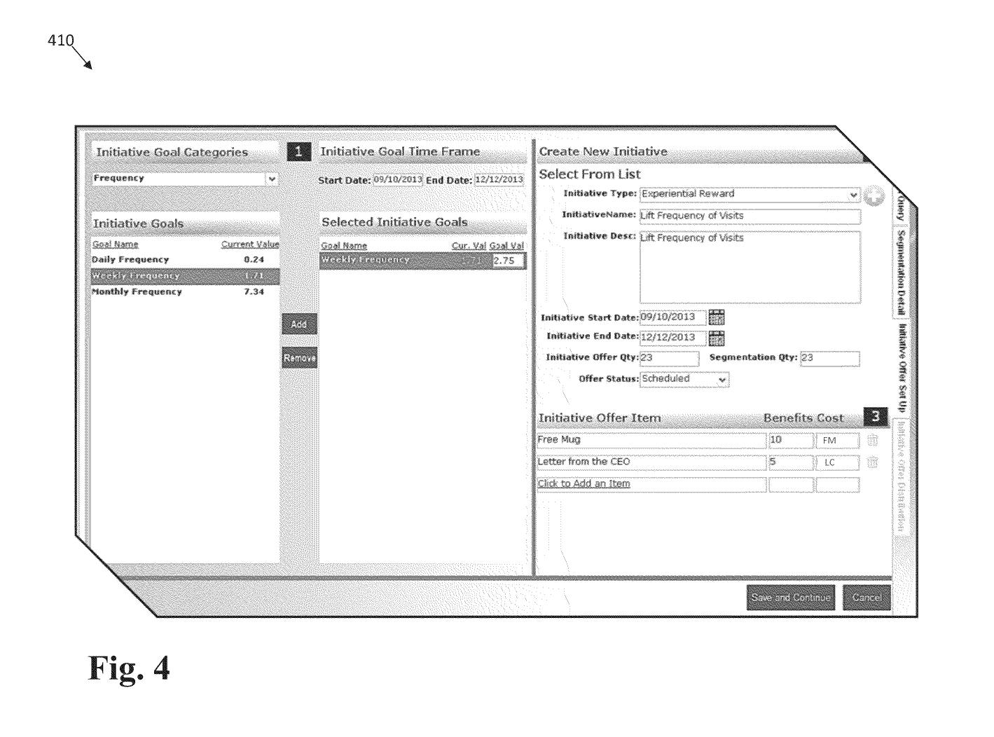

Benefits management system 114 includes a number of such software-based benefits management interfaces, for example as configured to input the benefits option selections described with respect to FIGS. 4-11 below. Suitable processor and memory components can also be provided, as configured for generating benefits program data based on the benefits option selections, and for managing the corresponding customer transaction history data.

Alternatively, one or more of such interfaces can also be presented on records manager 112, or implemented directly within adaptive benefits program server 110. One or more user-based interfaces can also be presented on web server 130.

Benefits server 110 also includes a transaction or point of sale (POS) data interface 323, which is configured for receiving the customer transaction histories in the form of transaction data from point of transaction system 120, and for transmitting the benefits program data to point of transaction system 120. An adaptive data matrix generator is also provided within server 110, and configured for generating user benefits data and adaptive matrix data representing adaptive data matrix 315.

The adaptive matrix (or user benefits) data are based on the customer transaction histories in combination with the benefits program data, so that adaptive data matrix 315 defines user identification and user transaction history data, as described above. Benefits server 110 may also include a mobile service interface or other matrix data interface 321, which is configured for transmitting the adaptive matrix data to selected mobile devices or other user devices 310, via mobile or wireless communications service 330.

Point of transaction system 120 is configured to offer customer and user benefits in response to presentation of adaptive data matrix 315, based on the corresponding customer transaction history in combination with locally stored benefits program data. For example, the customer can use a smartphone, tablet computer, or other mobile device 310 to presenting adaptive data matrix 315 to a scanner or other reader 122 at the transaction location, as described above.

Alternatively, user device 310 may be configured to print adaptive data matrix 315 in hard copy form, or a fob, magnetic card, smart card or radio frequency data device 310 may be utilized. In these applications, adaptive data matrix 315 may be presented to point of transaction system 120 in graphical form, or adaptive data matrix 315 may define substantially equivalent data in electronic, electromagnetic, or radio-frequency format.

FIG. 4 is an illustration of an initiative goal interface (I/F) 410 for adaptive benefits program server 110, for example as presented on benefits management system 114 of FIGS. 1-3. In the particular example of FIG. 4, initiative goal interface 410 is configured for selecting initiative goal categories and time frames, and for creating new initiatives (or modifying exiting initiatives) based on type, name and initiative details. Specific inputs include start and end dates, offer item type and quantity, and other offer details.

In some applications, particular offers may also be based upon customer segmentation and transactional history. Suitable segmentations include demographic and geographical categories, but initiatives and goals can also be defined based on transaction-specific information such as average check and current (or historical) speed of service. Offer items and quantities defining the benefits may thus be selected not only to meet initiative goals based on customer segmentation, but also for selected customers based on individual transactional histories.

The benefits offered, moreover, are not restricted to individual product offerings designed to influence average check value, margin, or other sales data, but can also be directed to quality factors such as service time and customer satisfaction. Such benefit offerings may include discounted offer bundles selected to reduce service time, as described above, as well as discounts selected for pre-ordering and/or pre-paying customers.

FIG. 5 is an illustration of segmentation interface 420 for adaptive benefits program server 110. Segmentation interface 420 provides for deep customer segmentations with diverse user subdivisions, including not only demographics such as age group, birthday and gender, but also transaction-based segmentations including average check, margin, payment method, frequency, redemption rate, and other purchasing patterns, as described in the FIG. 5. Segmentation interface 420 also provides for additional segmentations based on user feedback, including interactive voice recognition (IVR) and other survey data, for example likelihood of return and user perceptions of price, speed of service, and overall value.

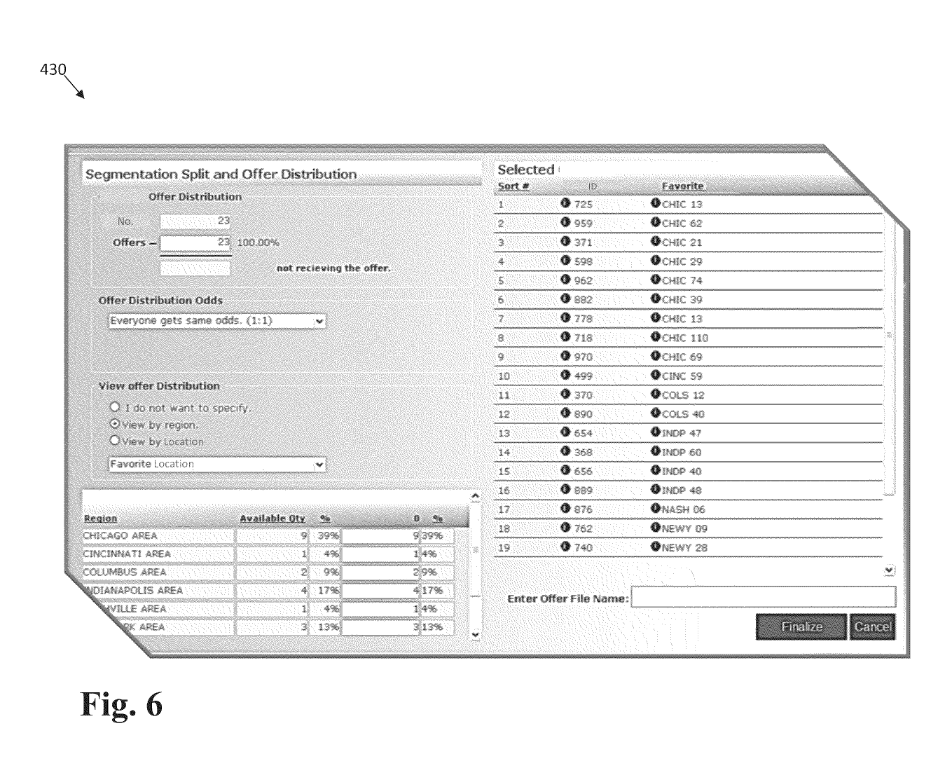

FIG. 6 is an illustration of segmentation split and offer distribution interface 430 for adaptive benefits program server 110. Segmentation split and offer distribution interface 430 allows for balancing and weighting of benefit offers by segmentation group, for example based on region or other demographic or geographic data.

Segmentation split and offer distribution interface 430 also provides for defining uniform or relatively increased or decreased odds of receiving a particular benefit offer, in order to weight initiatives by region, demographics and transaction-based segmentation categories. Control groups and holdouts can also be defined, for example by random selection within a given customer segmentation, or for comparing different customer segmentations, with the same or different offer initiatives and benefits.

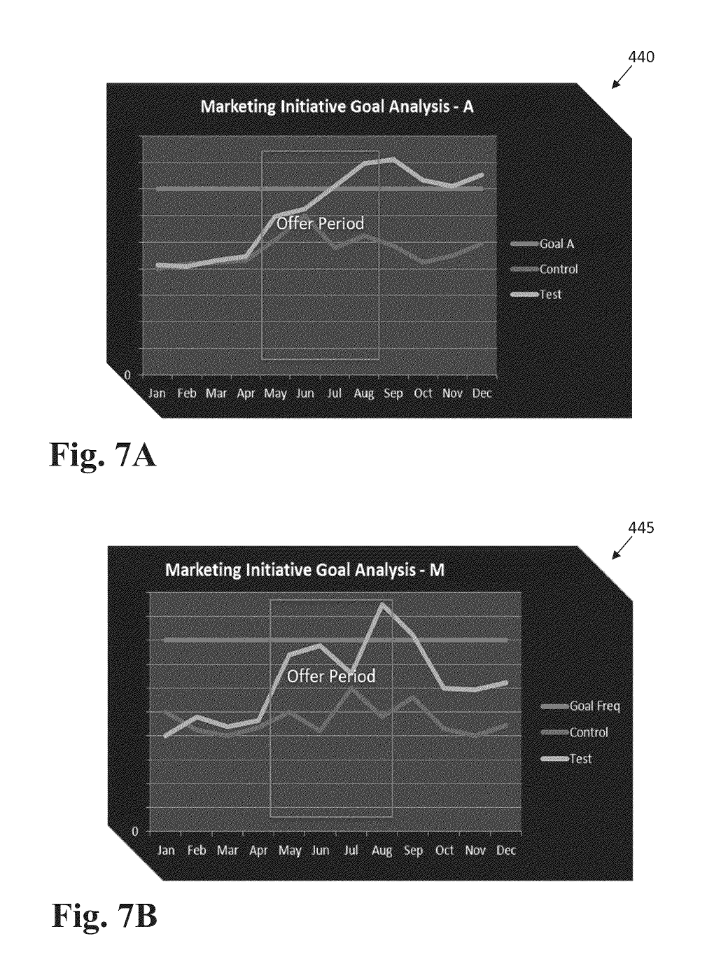

FIG. 7A is an illustration of a marketing initiative goal analysis interface 440 for adaptive benefits program server 110. As shown in FIG. 7A, long-range tracking can be provided, extending before and after the offer period, as defined by the start date of the offer and the end of the redemption period.

The performance of test groups to whom particular offers are made can also be compared to a control or comparison (holdout) group, to whom the benefit is not offered. Control groups may be randomly selected within a particular customer segmentation, as described above. Alternatively, comparison groups can be selected based on different customer segmentations, for example with different demographic or geographic features, or based on transactional history.

FIG. 7B is an illustration of an alternate marketing initiative goal analysis interface 445 for adaptive benefits program server 110. In this example, the marketing initiative is directed to a frequency-based goal such as user participation or number of store visits. As shown in both FIG. 7A and FIG. 7B, longer-term goal analysis can also be performed, not only during the offer and redemption periods, but also before and after these periods. Goal analysis can thus extract longer-range trending and performance data to determine persistent changes in user behavior, including trending and scaled performance evaluations extending for weeks, months or years after the end of the actual redemption period, and between and among multiple offer and redemption periods.

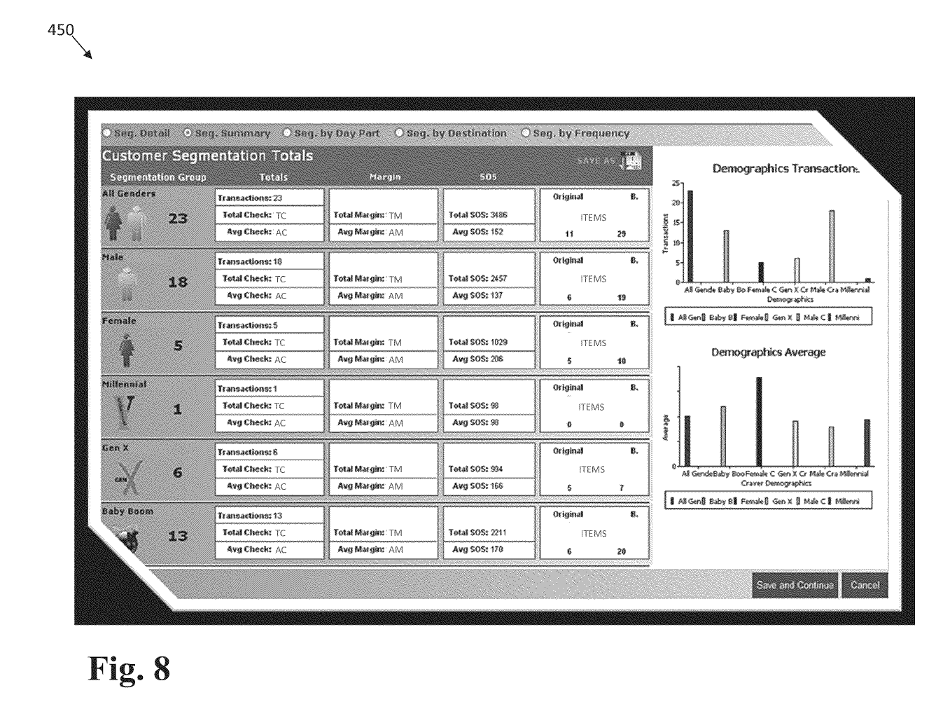

FIG. 8 is an illustration of segmentation grouping interface 450 for adaptive benefits program server 110. Grouping interface 450 presents data such as number of transactions, items, and average values for check, margin and time of service, arranged selected by user segmentation. Grouping interface 450 thus provides for double-checking and verification of the selected segmentations, for example to ensure that selected demographic and geographical groups match desired or preselected customer and user populations. Grouping interface 450 also allows for analysis of the resulting transactional data for the selected segmentations (e.g., particular demographic groups, genders, areas, ages, etc.), in order to provide a variety of cost-effective benefits across the entire (customer-wide) user and client base.

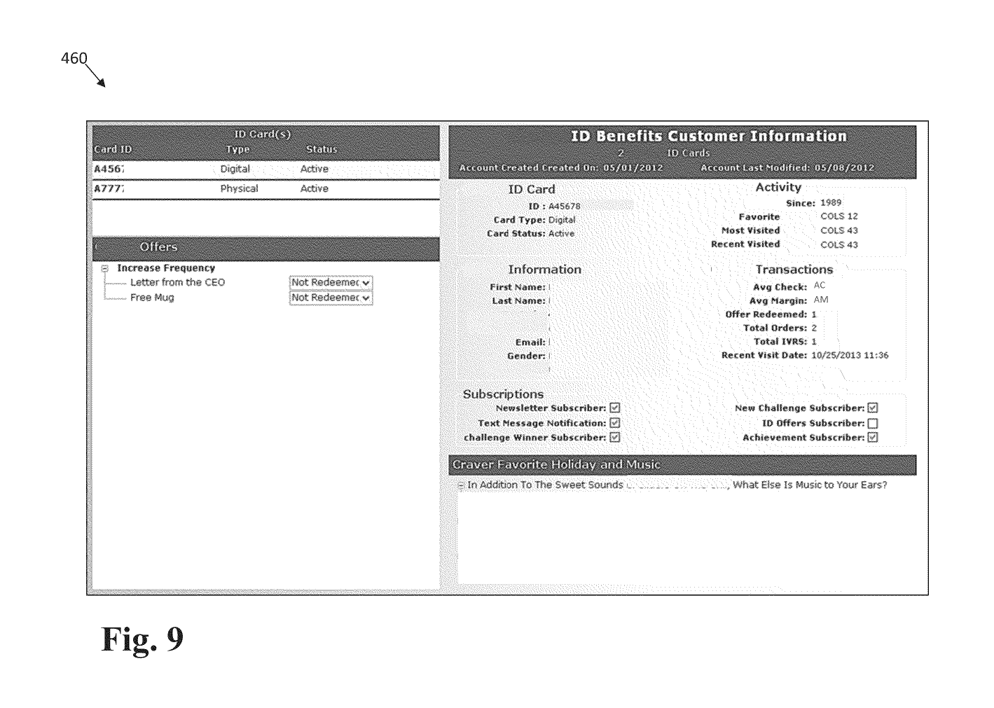

FIG. 9 is an illustration of ID benefits interface 460 for adaptive benefits program server 110, for example presented as a customer records management (CRM) screen on records manager 112. As shown in FIG. 9, ID benefits interface 460 presents activity data related to the physical devices on which the program is implemented, for example a mobile device, fob, or card (e.g., a smart card or digital card, a magnetic stripe card, or radio-frequency data device). Modes of user communication are also include, e.g., newsletter, text, and various challenge or other benefits program subscription data. Favorite (e.g., user-identified) and most frequently visited locations can also be included (e.g., based on transaction history), along with additional transactional data including average check and margin, number of orders, and customer feedback including interactive voice recognition (IVR) input and other survey results.

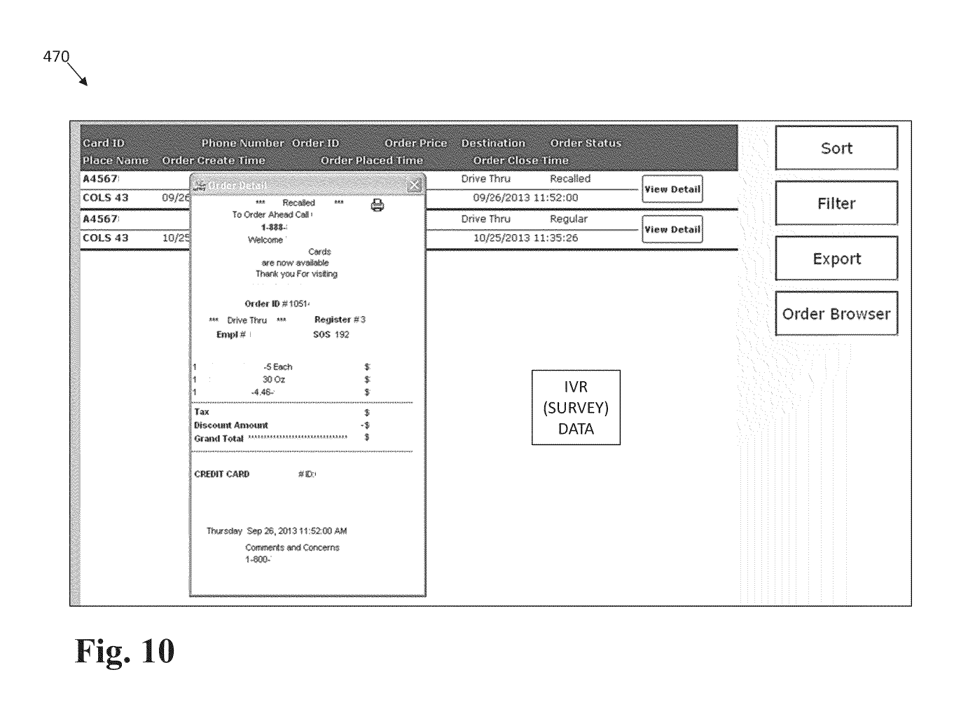

FIG. 10 is an illustration of order detail interface 470 for adaptive benefits program server 110. Order detail interface 470 provides detailed data related to particular transactions, including location, date, time, item selection, offer redemption or deferral, and other transactional details. Interactive voice recognition feedback and other user survey data can also be presented, as provided by the particular user or customer with whom the corresponding transaction was made.

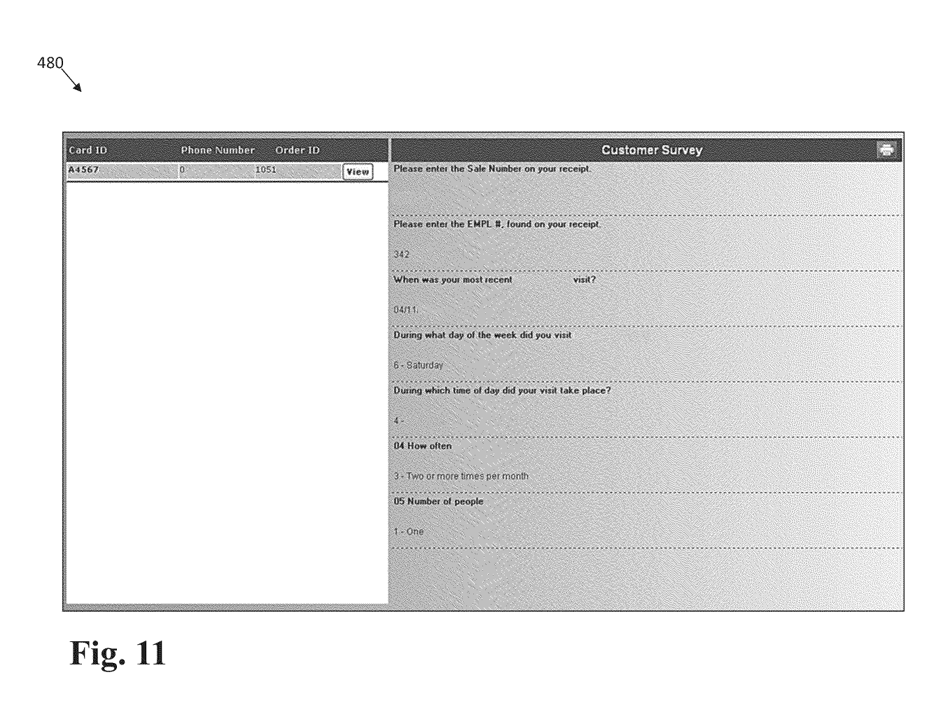

FIG. 11 is an illustration of customer survey interface 480 for adaptive benefits program server 110, for example as presented on web server 130 in communication with adaptive benefits program server 110. As shown in FIG. 11, representative customer or user feedback may include, but is not limited to, a ticket or receipt number associated with a particular transaction, employee number, timing and location data such as most recent visit, day and time, and number of people in a particular customer party or client group.

User feedback provided on survey interface 480 can be directly related to the corresponding transactions (e.g., as presented order detail interface 470 of FIG. 10), using the ticket or receipt number. Additional transaction-specific feedback may include, for example, customer perceptions of item and service quality, time of service, probability of repeat visit or repeat item selections, and overall customer satisfaction. Future benefits can thus be determined based on specific customer feedback in combination with the details of a particular associated transaction, for example a bundled or discounted combination offer selected to reduce service time and increase user satisfaction, or offers of alternative or discounted items based on user preference, number in party, and other customer feedback data.

While this invention has been described with reference to exemplary embodiments, it will be understood by those skilled in the art that various changes can be made and equivalents may be substituted without departing from the spirit and scope of the invention. Modifications can also be made to adapt the teachings of the invention to particular situations and materials, without departing from the essential scope thereof. The invention is thus not limited to the particular examples that are disclosed, but encompasses all embodiments falling within the scope of the appended claims.

1. A transaction method comprising:
storing benefits program data in memory of a point of transaction system;
reading an adaptive data matrix in association with a transaction at the point of transaction system, the adaptive data matrix defining user data indicative of a user and transaction history data indicative of a transaction history of the user;
offering a benefit to the user in the transaction, wherein the benefit is selected based on the transaction history of the user in combination with the benefits program data stored in memory; and
transmitting transaction data from the point of transaction system to a remote server, the transaction data selected for updating the transaction history with the offering made in the transaction, and for modifying the adaptive data matrix accordingly.

2. The transaction method of claim 1, further comprising updating the benefits program data stored in an asynchronous communication with the remote server, independent of the transaction with the user.

3. The transaction method of claim 1, wherein transmitting the transaction data to the remote server is performed in an asynchronous mode, independent of a time of the transaction with the user.

4. The transaction method of claim 3, wherein the benefit is selected by the point of transaction system based on the benefits program data stored in memory and the transaction history defined by the adaptive data matrix, absent communication with the remote server at the time of the transaction with the user.

5. The transaction method of claim 1, wherein the adaptive data matrix is presented by the user on a mobile device based on user benefit data received from the remote server, the user benefit data reflecting the updated transaction history of the user.

6. The transaction method of claim 1, wherein at least a portion of the benefits program data is not provided to the user prior to the transaction, such that the benefit is unknown to the user prior to the offering.

7. The transaction method of claim 1, wherein the transaction data transmitted to the remote server comprise location data indicative of a location of the point of transaction device, the location data retrievable by the user in the form of a virtual icon available on a web server in communication with the remote server, and the virtual icon indicative of presence of the user at the location.

8. The transaction method of claim 1, wherein the transaction history defined by the adaptive data matrix is indicative of participation by the user in a non-commercial community or charity event, the offering based at least in part thereon.

9. The transaction method of claim 1, wherein the transaction history defined by the adaptive data matrix is indicative of an average time of service for the user, the benefit selected at least in part thereon.

10. A transaction system comprising:
memory configured for storing benefits program data received from a remote server;
a reader configured for reading an adaptive data matrix presented by a user, the adaptive data matrix defining user data indicative of the user and transaction history data indicative of a transaction history of the user;
a transaction device configured for offering a benefit to the user in a transaction, wherein the benefit is selected locally by the transaction device based on the transaction history defined by the adaptive data matrix in combination with the benefits program data stored in memory, absent communication with the remote server at a time of the transaction with the user; and
a data interface configured for transmitting transaction data indicative of the transaction to the remote server, the transaction data selected for updating the transaction history of the user and for modifying the adaptive data matrix accordingly.

11. The transaction system of claim 10, wherein the data interface is configured for transmitting the transaction data and updating the benefits program data in an asynchronous communication with the remote server, independent of the transaction with the user.

12. The transaction system of claim 10, wherein the adaptive data matrix is presented on a mobile device based on user benefits data received at the mobile device from the remote server, the user benefits data reflecting the updated transaction history of the user.

13. The transaction system of claim 10, wherein the transaction data are indicative of an average service time for completing transactions with the user, and wherein the transaction history defined by the adaptive data matrix is updated based on the average service time.

14. The transaction system of claim 13, wherein the transaction device is configured to select the benefit based on the updated transaction history reflecting the average service time.

15. The transaction system of claim 10, wherein the transaction data transmitted to the remote server comprise location data indicative of a location of the point of transaction device, and wherein the transaction history defined by the adaptive data matrix is updated based on the presence of the user at the location.

16. The transaction system of claim 15, wherein the location data are indicative of participation of the user at a non-commercial community activity or charity event, and wherein the transaction history defined by the adaptive data matrix is updated based on participation of the user at the non-commercial community activity or charity event.

17. A computer-based adaptive customer benefits program apparatus comprising:
a records manager having memory configured for storing a plurality of individual customer transaction histories;
a benefits management system in data communication with the records manager, the benefits management system configured for inputting benefits options and generating benefits program data based on the benefits options and the customer transaction histories;
a data interface configured for transmitting the benefits program data to a point of transaction device; and
a server in data communication with the benefits management system and the data interface, the server configured for generating user benefits data representing an adaptive data matrix based on selected customer transaction histories in combination with the benefits program data, the user benefits data being transmitted to a mobile device associated with each of selected customer transaction histories;
wherein the point of transaction device is configured for offering a benefit in response to presentation of the adaptive data matrix.

18. The benefits management system of claim 17, wherein the offering is determined locally by the point of transaction device based on the customer transaction history and the benefits program data, absent synchronous communication with the server.

19. The benefits management system of claim 17, wherein:
the data interface is configured for receiving customer transaction data associated with the selected customer transaction histories from the point of transaction device;
the records manager is configured for updating the selected customer transaction histories based on the associated customer transaction data; and
the server is configured generate the user benefits data based on the updated customer transaction histories, such that the adaptive data matrix reflects the associated customer transaction data.

20. The benefits management system of claim 19, wherein the associated customer transaction data is indicative of one or more of a location of the point of transaction device and an average service time for a customer associated with the customer transaction data, the benefit selected at least in part thereon.
